(19) United States
(12) Patent Application Publication
(10) Pub. No.: US 2004/0102936 A1
(43) Pub. Date: May 27, 2004

(54) Method and system for designing and evaluating linear polymers

(76) Inventors: Neal B. Lesh, Cambridge, MA (US); Michael D. Mitzenmacher, Lexington, MA (US); Sue H. Whitesides, Somerville, MA (US)

Correspondence Address: Patent Department, Mitsubishi Electric Research Laboratories, Inc., 201 Broadway, Cambridge, MA, 02139, US

(21) Appl. No.: 10/302,596

(22) Filed: Nov. 22, 2002

(51) Int. Cl. G06F 17/10

(52) U.S. Cl. 703/2

(57) ABSTRACT

A method and system models a multi-dimensional linear polymer in a computer system. The linear polymer includes sequentially linked elements such as amino acids in a protein. The model initially is in a valid configuration of the polymer. The model includes multi-dimensional grid of nodes, and the elements corresponding to selected nodes of the grid. Linear local transforms are applied to selected elements of the linear polymer to produce a different valid configurations. The different valid configurations are scored and searched for the configuration having a lowest free energy.

### FIELD OF THE INVENTION

The present invention relates generally to the field of identifying, designing, synthesizing, and evaluating molecular structures, and more particularly to modeling linear polymers such as proteins.

### BACKGROUND OF THE INVENTION

A polymer is a chemical compound with a relatively high molecular weight. Polymers include a number of structural elements linked together by covalent bonds. A structural unit is a group of elements having two or more bonding sites. A bonding site can result from the loss of an atom or group, such as H or OH, or by the breaking up of a double or triple bond, as when ethylene is converted into a structural unit for polyethylene. Simple polymer structural elements are monomers. Two monomers can combine to form a dimer, three form a trimer, and so forth.

Of special interest to the present invention are linear polymers. Here, the structural elements are connected linearly in a chain, and thus need only be bi-functional, i.e., have two bonding sites, e.g., glycerin and divinyl benzene. Many linear polymers occur in nature, such as silk, cellulose, natural rubber, and, of course, proteins.

Proteins are essential to all living organisms. In living organisms proteins are encoded by the genes of DNA, for example, humans have about 50,000 different proteins. Sequences of DNA bases called genes encode the proteins in cells. The majority of all enzymes and functional elements of living organisms are proteins. Proteins are formed by combining any of the twenty amino acid building blocks into an unbranched linear polymer. The number of building blocks in a protein can range from less than a hundred to many thousands. Obviously, the different combinations and permutations of these building blocks makes the number of possible proteins huge.

For a linear polymer to function to achieve a desired result, it must first fold into a three-dimensional structure that has a minimum free energy state. From X-ray crystallographic and nuclear magnetic resonance (NMR) imaging techniques, it has been learned that proteins are folded into a backbone and various side chains. The backbone can be characterized by dihedral angles, phi and psi, for each amino acid. There is little variation in the covalent bond lengths and three-atom bond angles among proteins. It is estimated that there 2000 different types of folds possible. Therefore, the number of ways that a particular protein can fold is very large.

A large number of linear polymers have been synthesized in the laboratory, leading to such commercially important products as plastics, synthetic fibers, and drugs. Polymerization, the chemical or biological process of forming polymers from their component monomers, is often a complex process. When designing proteins, coming up with the right structure to have some biological effect is an essential part of the process. For example, one synthetic protein called 5-Helix jams the “grappling hook” used by HIV to attach to target cells. This synthetic protein prevents a spring-loaded component of the grappling hook from snapping shut and drawing the virus to its target, one of the key steps in HIV infection. Perhaps altering the protein to make it larger, the risk of elimination by the kidneys can be reduced. The addition of carbohydrate molecules could shield it from the immune system.

The large number of structural possibilities make it very difficult to design proteins that meet the minimum energy requirement. For this reason, attempts have been made to apply computerized modeling methods to the problem of optimal protein folding.

One prior art model is a two-dimensional hydrophobic-hydrophilic model. In this model, amino acids are labeled as either hydrophobic (H) or hydrophilic (Polar). Therefore, the model is generally referred to as the 2D HP model. With this model, the sequence of amino acids is placed on a 2D grid without overlapping, so that adjacent amino acids in the sequence remain horizontally or vertically adjacent in the grid. The goal is to minimize the free energy, which in the simplest variation corresponds to maximizing the number of adjacent hydrophobic pairs.

Although the model is extremely simple, it captures the essential features of the protein folding problem. Mathematically, this problem is NP-complete, and hence unlikely to be solved in polynomial time.

Some modeling methods used with the HP model use approximation process, although these are generally not helpful for finding minimum free energy configurations. Therefore, it is desired to find a method for modeling proteins that overcomes the problems of prior art protein folding techniques.

### SUMMARY OF THE INVENTION

A method and system models a multi-dimensional linear polymer in a computers system. The linear polymer includes sequentially linked elements such as amino acids in a protein. The model initially is in a valid configuration of the polymer. The model includes multi-dimensional grid of nodes, and the elements corresponding to selected nodes of the grid.

Linear local transforms are applied to selected elements of the linear polymer to produce a different valid configurations. The different valid configurations are scored and searched for the configuration having a lowest free energy.

### BRIEF DESCRIPTION OF THE DRAWINGS

FIG. 1 is a flow diagram of a method for modeling linear polymers according to the invention;

FIG. 2A is a block diagram of a polymer model used by the invention;

FIG. 2B is a block diagram of a square configuration used during a transform according to the invention; and

FIGS. 3A-3E are diagrams pull moves according to the invention.

### DETAILED DESCRIPTION OF THE PREFERRED EMBODIMENT

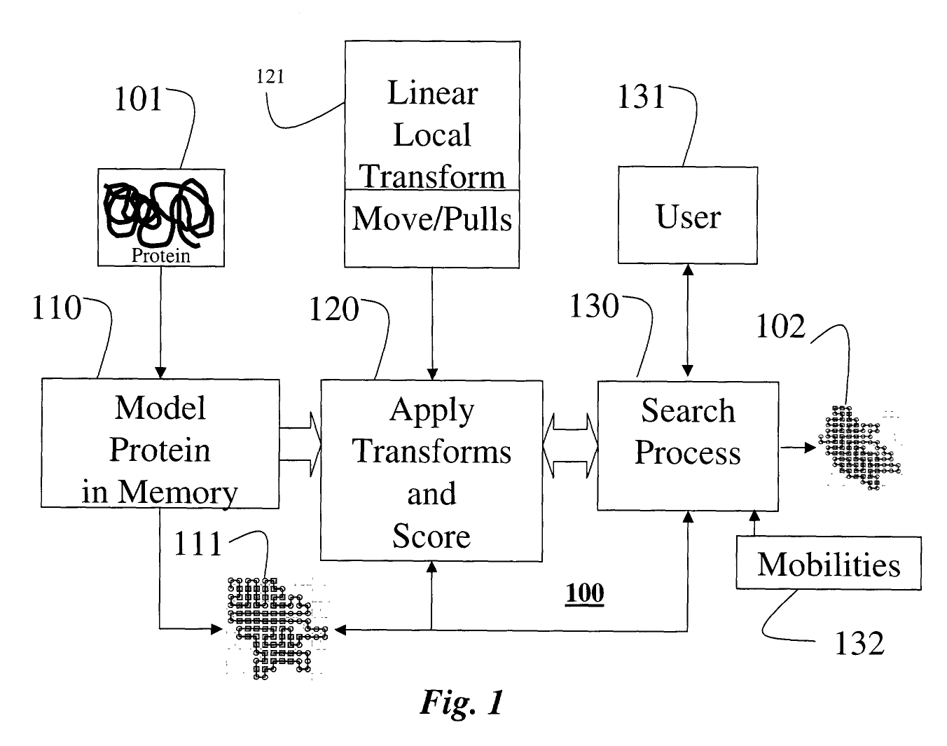

As shown in FIG. 1, a method 100 for folding a linear polymer, for example, a protein 101, according to the invention is a novel combination of three different technologies. First, we use a multi-dimensional polymer model 111 to express 110 the linear polymer 101. The model can be stored in a memory of a computer system. Second, we apply 120 linear local transforms 121 to the model 111. The transformed models are scored according to free energy. Third, we use a search process 130 to find a configuration 102 of the model 111, after the transforms 121, that has a minimum free state energy.

The model 111 can be a sequence of two or more molecular elements, e.g., amino acids, in a two- or three-dimensional space. The transforms 121 are loosely based an a reptation model for polymer motion, see below. In the preferred embodiment, the search process 130 is based on a “tabu” search, although other search strategies, such as hill climbing, simulated annealing, greedy search, can also be used.

It should be noted that although the preferred embodiment of the invention is described using a protein as an example, the invention can be used to model any linear polymer that has well defined physical affinity properties.

### The Linear Polymer Model

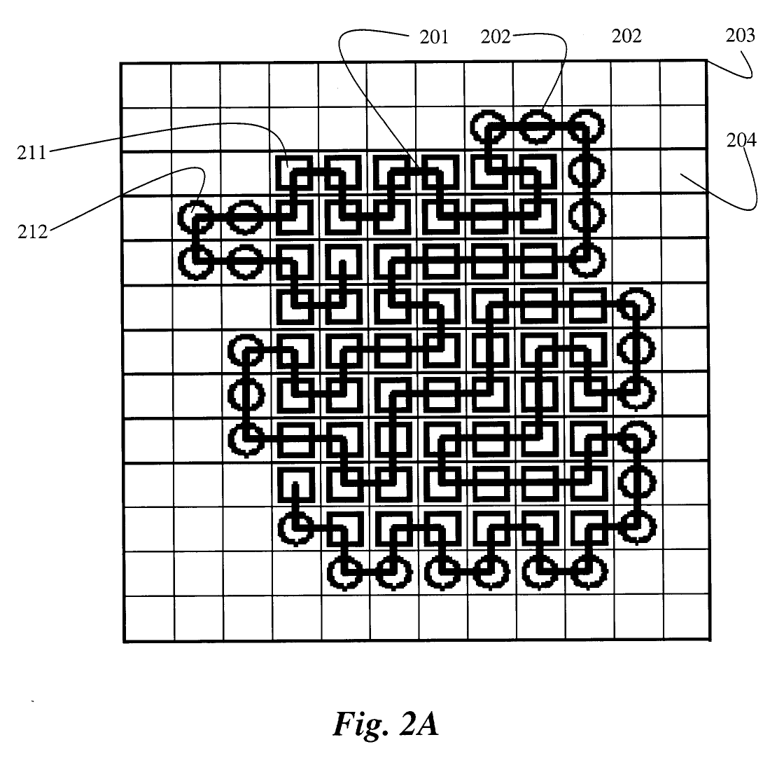

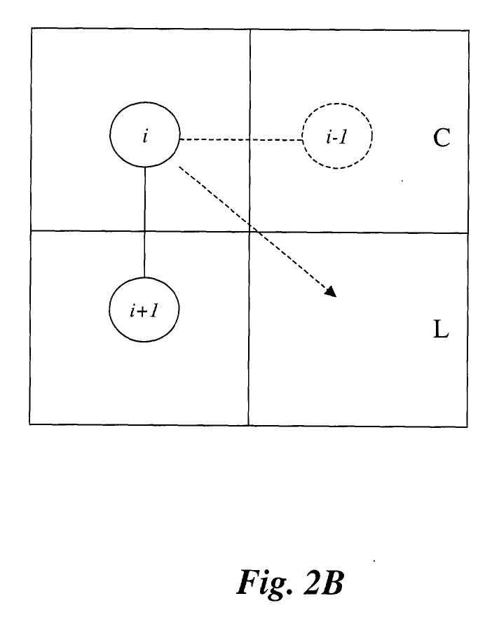

As shown in FIG. 2A in graph theoretic terms, the polymer 101 is represented combinatorially as a chain 201 of n vertices 202 embedded as a simple, i.e., non-self-intersecting, path P in a unit grid 203 of nodes 204. The grid can be 2D or 3D. Vertices that are adjacent in the chain must be placed at adjacent nodes in the grid. Each vertex is assigned a weighted value according to physical properties of the corresponding element in the polymer. For example, if the 2D HP model is used, then the values of the square and round vertices 210 and 211 are 0 and 1, respectively, to represent hydrophilic (P) and hydrophobic (H) amino acids.

A score of a particular path 201 is a sum of the weighted values of adjacent vertices. The score contributes to the free energy of a configuration of the polymer. In the 2D HP model, the only valid interactions that are counted are between pairs of vertices that are adjacent in the grid and both labeled H, as shown in Table A.

TABLE A

| | H | P |
|---|---|---|
| H | 1 | 0 |
| P | 0 | 0 |

More formally, we define the following terms. A location is a node 204 of the grid 203 corresponding to an (x, y) coordinate pair. Locations are said to be adjacent only if they are adjacent horizontally or vertically.

Similarly, two locations are diagonally adjacent if they lie one horizontal and one vertical step from each other. A vertex is a node of the chain, i.e., the polymer 101. A vertex has a value, e.g., H=1 and P=0. Vertices are numbered consecutively from 1 to n along the chain. A valid configuration of the chain lies along a non-self-intersecting grid path P of locations such that adjacent vertices occupy adjacent locations.

In describing our transformation/scoring 120 and search 130 processes, we refer to the configuration of a path P at different time points t as P(t) defines the configuration at time t.

For j>i, a path from vertex i to vertex j, inclusive, is denoted Pᵢⱼ(t). The location occupied by vertex i at time t is denoted by (xᵢ(t), yᵢ(t)). A location is free at time t when there is no vertex at the location.

The free energy of a polymer configuration is obtained by summing the values of adjacent pairs of vertices that are not consecutively numbered, multiplied by −1. In the present example as described above, the values are either zero or one.

The goal of the invention is to find the configuration of the polymer with a lowest free energy.

### Transforms

A linear local transform 121 comprises a linear move followed by one or more local pulls until a valid configuration is reached. There are two types of linear moves. An end move operates only on the two end elements of the polymer or chain, while interior moves operate on all other (not end) elements of the chain.

In an end move, the end element is moved two nodes in the same direction to a valid free node along a major axis of the model, e.g., x, y, or z in a 3D model or two nodes horizontally or vertically in a 2D model.

In an interior move, an element is moved two nodes in different directions, i.e., along a diagonal, to a valid free node, e.g., one up followed by one sideways. These two linear moves are described in greater detail below.

A pull basically moves each next adjacent element to the free node previously occupied by the moved element until a valid configuration is reached. If the initial move results in a valid configuration, then the pull is not necessary and becomes a null operation.

Our transform moves are loosely based on the classic de Gennes reptation model for polymer motion, see de Gennes, Journal of Chemical Physics, Vol. 55, p. 572, 1971, Scaling Concepts in Polymer Physics, Cornell University Press, 1979. According to that model, which is widely used in polymer physics, the motion of a mobile polymer chain moving through an environment is governed by slack entering at the ends of the polymer and diffusing along its entire length. Simply stated, a snakelike motion is achieved by the ability of the ends of the chain to randomly explore possible conformations. That model has been applied both to polymers diffusing in environments with fixed obstacles as well as to polymers diffusing in more flexible media, such as dense solutions.

Our novel linear local transforms are distinguishable from the Gennes reptation as follows. A de Gennes reptation begins only at an end of chain that can move anywhere. In contrast, we can begin anywhere but move only linearly in a constrained manner. The Gennes reptation diffuses globally throughout the entire length of the chain. Our transforms diffuse only locally.

We are guided in our selection of possible transforms by several desired properties. We begin with definitions of reversible, complete and local transforms.

A transform 121 is a function that takes as input a valid chain configuration with a path P(t), and produces a valid next configuration with a path P(t+1).

A set T of transforms is reversible if, for any move in T applied to a configuration of path P(t) to obtain a configuration of path P(t+1), there is some transform T¹ in the set T that can accept P(t′)=P(t+1) as input and produce P(t′+1)=P(t). Reversibility is useful in proving completeness, as we described below.

The set T of transforms is complete if, given any configuration of paths P and P′, there is a sequence of transforms in T that relocates P to a configuration that is congruent, after translation and rotation, to P′. It is clearly beneficial that our set of transforms be complete, otherwise the search process 130 using these transforms cannot reach all configurations, and thus, might miss an optimal solution.

Furthermore, it is also desirable from the standpoint of having an effective local transform and search process, as well as for simplifying user interaction 131, that the transforms generally avoid drastic changes that invalidate the global structure of the current configuration. Hence, in contrast with the prior art global reptation, our transforms are local. That is, our transforms displace a small number of vertices, and transformations never diffuse to vertices far from the current location.

In other words, our transforms are more natural. We move one amino acid a small linear distance, and then pull the chain along, generally stopping well before the end of the chain is reached, unless no valid configuration is possible. Most of the time, we stop as soon as possible, i.e., as soon as the first valid configuration is reached. Occasionally, we may pull some additional elements to explore other localized valid configurations.

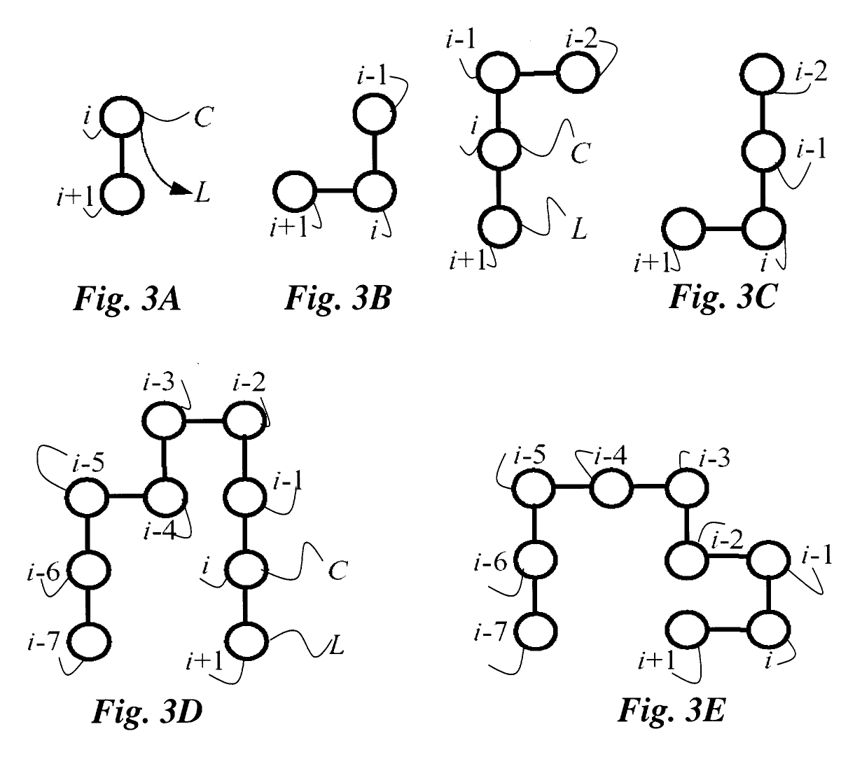

We now describe our reversible, complete, and local transforms in terms of how they are implemented with reference to example transforms in FIGS. 2B, 3A-3E. Although we describe transforms on a 2D grid, it should be clear from the description below that our linear local transforms can be extended to 3D and higher dimensions.

Consider a vertex i at time t at a location (xᵢ(t), yᵢ(t)). Suppose that a free location L is adjacent to (xᵢ₊₁(t), yᵢ₊₁(t)), and diagonally adjacent to (xᵢ(t), yᵢ(t)). The vertices (xᵢ(t), yᵢ(t)), (xᵢ+, (t), yᵢ₊₁(t)), and the free location L constitute three corners of a square. Let the fourth corner be the location C. For an interior move to occur, the location C must either be free or must equal (xᵢ₋₁(t), yᵢ₋₁(t)).

When C=(xᵢ₋₁(t), yᵢ₋₁(t)), the entire interior move consists of moving vertex I diagonally to location L. When C is free, the first vertex i is pulled to location L, and the vertex i−1 is pulled to location C. Then, until a valid configuration is reached, the following action are performed.

Starting with vertex j=i−2 and down to vertex 1, set (xⱼ(t+1), yⱼ(t+1))=(xⱼ+2}(t), yⱼ+2(t)). That is, vertices are pulled two nodes up the chain until a valid configuration is reached. Notice that this ensures that a valid configuration is maintained between transformations. Vertices i and i−1 have moved to free locations, and the lower indexed vertices are repeatedly pulled into vacated locations.

If the pull goes down to vertex 1, then a valid configuration will always be reached. However, in contrast with the prior art, we stop as soon as a valid configuration is reached, or soon thereafter. This ensures the locality of the transform, in that fewer vertices change position. In practice, most transforms displace a small number of vertices, e.g., less than ten. Note that the chain is transformed over an even multiple number of locations, e.g., two, due to the parity implicit in working on a unit grid.

We have described the transform vertices from vertex i down to vertex 1. Similarly, we can consider a transform in the other direction, starting from a free location L adjacent to (xᵢ₋₁(t), yᵢ₋₁(t)) and diagonally adjacent to (xᵢ(t), yᵢ(t)).

Finally, to make our transforms reversible, we have some special moves for the end vertices 1 and n. Consider any path of two free locations, with one of the locations adjacent to the last vertex n in the chain. We can move vertices n−1 and n to these two free locations, and then pull the remaining vertices: starting with vertex j=n−2 and down to vertex 1. If the path is not in a valid configuration, then set (xⱼ(t+1), yⱼ(t+1))=(xⱼ+2(t), yⱼ₊₂(t)). We have similar transform for vertex 1, the beginning of the chain.

FIGS. 3A-E show specific examples of transforming a local group of vertices. In FIG. 3A, a transform begins with moving vertex i moves to a free location L. In the case where the corner C holds vertex i−1 in FIG. 3B, the transform is complete. Otherwise in FIG. 3C, vertex i−1 is pulled to C. It is possible that this completes the transform. If this does not complete the move in FIG. 3D, then vertex i−2 is pulled to the position previously held by vertex i, vertex i−3 is pulled to the position previously held by vertex i−1, and so on until a valid configuration is reached. Here, vertex i−3 is pulled, but then the transform is complete in FIG. 3E.

To help think about transforms that affect the location of three or more vertices, we suggest the following intuition. The transform starts by creating a loop in the form of a square, as shown in FIG. 2B. That is, four consecutive vertices are put in a square formation. The vertices are pulled along in one direction until another square loop is reached. At this point, the existing square loop is undone and the transform ends.

### Reversible Transformations

This follows by a case analysis. Transforms that re-locate just one or two vertices are clearly reversible, so we focus on transforms that re-locate three or more vertices.

Without loss of generality, suppose that local vertices i to k inclusive are transformed, for k<i. In the case where k>1, the transform has found an early stopping location. The example above clarifies this case. To reverse the transform, we recreate the square loop by moving vertices k and k+1 back to their original positions and pull in the other direction. This pull must go back to the square that was created by moving vertices i and i−1. It is impossible for this transform to stop before moving vertex i, because the square created by moving vertices i and i−1 must be the first square reached by the reverse move. Otherwise, the original transform has found a square before vertex k.

More formally, in this case, at time t vertices j and j+3 cannot be adjacent for k<j<I−2, or the transform would have stopped before reaching k. To undo the transform, note that (xₖ₋₁(t), yₖ₋₁(t)), (xₖ(t), yₖ(t)), (xₖ₊₁(t), yₖ₊₁(t)), and (xₖ₊₂(t), yₖ₊₂(t)) must have formed a square. We can therefore reverse the transform by moving vertices k and k+1 back to their original positions and pull in the other direction.

Suppose, for a contradiction, that the last vertex to change position in the reverse transform is vertex m, with k<m<i−2. Then, vertices m+1 and m−2 were adjacent after the first move. However, this implies that vertices m+3 and m were adjacent in the original configuration at time t, which is a contradiction. We can also show that the reverse transform cannot stop at vertices i−2 or i−1 by explicitly checking these cases.

The case for k=1, the transform is applied to the end of the chain. Here, we make use of the fact that in reversing the transform, we can move the end of the chain along any adjacent path of length two.

The transforms are complete because there is some sequence of transforms that turn any valid path into a horizontal or vertical line. Then, reversibility implies that any valid configuration can be turned into any other valid configuration via a sequence of transforms, because for any two configuration with paths P and P′, we can transform from P to the horizontal line, and then from the horizontal line to P′. Initially, both ends of the chain can be deep inside the configuration, surrounded, for example, by spirals.

We note that the transforms above can be generalized, so that instead of pulling the chain two node, the chain is pulled any even number of nodes. This is described in further detail below.

### Any Path P can Form a Straight Line

We now describe how a sequence of transforms can straighten out one of the tails of the chain from any starting position to yield a straight horizontal (or vertical) path. Then, we take advantage of this premise to straighten the rest of the chain. In 3D, a path lies in the plane of one of the major axes.

Let L(t) and R(t) denote, respectively, the leftmost and rightmost vertical grid lines containing at least one edge of a chain configuration P(t). Possibly L(t)=R(t). If P(t) contains no vertical edge, then the chain is already straight and horizontal, so from now on, suppose that P(t) contains a vertical edge. The exterior region at time t is the set of locations that are neither on, nor between, L(t) and R(t).

First, consider the case that an endpoint of path P(t) lies on the grid lines L(t) or R(t), or in the exterior region. For example, suppose vertex 1 lies on line L(t) or to the left of line L(t). If vertex 1 is left of L(t), then it is joined to a vertex on L(t) by a horizontal subchain. In either case, the locations to the left of vertex 1 are unoccupied, and applying a sequence of pull moves that pull vertex 1 two nodes to the left each time eventually yields a horizontal line. The situation where 1 is on or right of line R(t) is handled similarly.

The only remaining case is that vertex 1 lies strictly between lines L(t) and R(t). Proceeding along the chain from vertex 1, let vertices i and i+1 constitute the first edge lying on lines L(t) or R(t). Suppose, without loss of generality, this edge lies on line L(t). Then, the two locations immediately to the left of vertices i and i+1 are free. Hence, we can move vertex i to the left of vertex i+1, applying the linear local transformation that pulls vertices i down to, possibly, vertex 1.

In the new configuration, the left boundary L(t+1) is one unit to the left of L(t), with vertices i and i−1 lying on this boundary. Hence, this process can be repeated by moving vertex i−1 to the left of i, and so on, until vertex 1 reaches the left boundary, at which time the chain can be straightened as described earlier.

### Search Process

After the transformation 121 has been applied to the model 110 and the transformed model is scored, the new protein structure is searched 130 to provide an efficient optimized design systems. In one embodiment of the invention, we use a human guided search so that the user 131 can manually modify solutions, backtrack to previous solutions, and invoke, monitor, and halt a variety of search processes. We prefer a human guided search as described in U.S. patent application Ser. No. 10/117,495, “Human-Guided Optimization with Tabu Search,” filed by Lesh et al., on Apr. 5, 2002, incorporated herein by reference in its entirety. There, we distinguish the human guided search from the classical search or optimization process, which are not guided but execute automatically, potentially leading to infeasible solutions. The human guided search as described there by Lesh et al. is effective for a variety of problems including jobshop scheduling, edge-crossing minimization, and the selective traveling salesman problem.

To apply a human guided search to the present problem of protein folding, each problem instance is composed of a finite number of elements. For our purposes here, the elements are the vertices in the given sequence of elements, and each move is an operation on one problem element and altering that element, and possibly others.

In the context of the present invention, a transform operates on vertex i when the transform begins by moving i to a diagonally adjacent location, or if vertex i is an endpoint that is moved initially. Each transform is defined as altering all vertices that are moved to a new location on the grid.

The primary mechanism for guiding the search process 130 is to assign mobilities 132 to the problem elements. Each element is assigned high, medium, or low mobility. The search process 130 process is only allowed to apply transforms that operate on a high mobility element and that do not alter any low mobility elements. Such transforms are called valid. All other transforms are invalid or tabu.

For example, in the 2D HP model 111, a vertex with low mobility remains in its current location after any valid transform. Mobilities can be assigned by the user to guide, or constrain, the search process 130. To operate the search process 130 with minimal or no guidance, all elements are initially assigned a high mobility. However, mobilities are also used by the search process 130 to control an “unguided” search.

In each iteration, the process 130 evaluates all valid transforms. Then, the process applies the transform that yields a new configuration with the lowest free energy, even if the free energy of the new configuration is greater than the free energy of the previous configuration before the transform was applied. Then, the mobilities are updated to prevent cycling and to encourage exploration of new regions of the search space as follows.

First, all altered elements are set to medium for memorySize iterations, where memorySize is one of the control parameters for the process 130. Second, random element are set to medium mobility for one iteration, with a noise (Gaussian) probability. Third, the process preferentially selects transforms that alter elements that have been altered less frequently in the past based on a minDiv control parameter.

As an advantage of the search process 130, a current state of the search can be displayed to the user 131 to visualize the progress of the search process. The search process 130 uses domain-specific functions for comparing configurations, producing transforms, applying transforms to configurations to generate new configurations, identifying the altered elements, and producing initial configurations.

### EFFECT OF THE INVENTION

The method according to the invention was applied to well known benchmark sequences (SA64, S85, S100a, and (S100b), see König et al., “Improving genetic process for protein folding simulations by systematic crossover,” BioSystems, 50:17-25, 1999, Liang et al., “Monte Carlo for protein folding simulations,” Journal of Chemical Physics, 115(7):3374-3380, 2001, and Toma et al., “Contact interactions method: A new process for protein folding simulations,” Protein Science, 5:147-153, 1996.

When the present invention was applied to the benchmark sequences, we surprisingly found lower free energy states for the three out of the four longest benchmark sequences, the fourth was equaled. Thus, one effect of the invention demonstrates that previously believed putative ground states were not ground states. These results were obtained in a reasonable amount of time, even with loosely-tuned control parameters.

A particularly compelling example is a sequence we call “S85.” König et al. stated that the optimal ground state has energy −52. It appears that they constructed that sequence themselves with an optimal solution in mind to test their process. Their genetic process found a ground state of −47. Liang et al. used an evolutionary Monte Carlo process and found a ground state of −52, but only by specifying constraints that significantly cut down the search space. That is, their process was modified to constrain specified subsequences of hydrophobic residues, covering approximately 40% of the sequence to take one of three forms. Therefore, their solutions are highly structured.

Unexpectedly, our process finds several configurations with a free energy of −53. Furthermore, our configurations do not have the secondary structures described by Liang et al. Indeed, our configuration seems quite unstructured. This demonstrates the potential risk of searching only for structured configurations, as done in the prior art.

We can improve the performance of our method with a simple restart strategy. We repeatedly run the process for between 1,000 and 10,000 iterations, chosen randomly and uniformly from that range. Each time we restarted, we restarted from the best configuration found so far with new control parameters to get better results.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A computerized method for modeling a multi-dimensional linear polymer, the linear polymer including a plurality of sequentially linked elements, comprising:
expressing the linear polymer as a model having a valid configuration, the model including a multi-dimensional grid of nodes, the elements corresponding to selected nodes of the grid;
applying a plurality of linear local transforms to selected elements of the linear polymer to produce a plurality of different valid configurations;
scoring the different valid configurations; and
searching the plurality of different valid configurations for a particular configuration having a lowest free energy.

2. The method of claim 1 wherein the linear polymer is a protein and the elements are amino acids.

3. The method of claim 1 further comprising:
combinatorially representing the linear polymer as a chain of vertices representing adjacent elements embedded in adjacent nodes of the multi-dimensional grid to form a non-self-intersecting path.

4. The method of claim 3 further comprising:
assigned a weighted value to each vertex according to physical properties of the corresponding element in the linear polymer.

5. The method of claim 4 wherein the values are either 0 or 1.

6. The method of claim 5 wherein the values 0 and 1 respectively represent hydrophilic and hydrophobic amino acids.

7. The method of claim 6 further comprising:
combinatorially representing the linear polymer as a chain of vertices representing adjacent elements embedded in adjacent nodes of the multi-dimensional grid to form a non-self-intersecting path; and
summing weighted values of pairs of adjacent vertices that are not consecutively numbered to determine the free energy.

8. The method of claim 1 wherein the linear local transform comprises a linear move followed by one or more local pulls until the different valid configuration is reached.

9. The method of claim 8 wherein the linear move operates on an end element of the linear polymer, and further comprising:
moving the end element two spaces in a same direction along a major axis of the model to a valid free node.

10. The method of claim 8 wherein the linear move operates on an interior element of the linear polymer, and further comprising:
moving the end element two spaces in different direction along major axes of the model to a valid free node.

11. The method of claim 8 further comprising:
moving adjacent elements to a free node previously occupied by the moved element until a valid configuration is reached.

12. The method of claim 1 wherein the linear local transforms are reversible, complete.

13. The method of claim 1 wherein the search is human guided.

14. The method of claim 1 wherein the search is a tabu search.

15. The method of claim 13 further comprising:
assigning a mobility to each element.

16. A system for modeling a multi-dimensional linear polymer, the linear polymer including a plurality of sequentially linked elements, comprising:
a memory configured to store a valid model of the linear polymer, the model including a multi-dimensional grid including nodes, elements;
means for applying a plurality of linear local transforms to selected elements of the linear polymer to produce a plurality of different valid configurations; and
a search engine configured to search the plurality of different valid configurations for a particular configuration having a lowest free energy.
